(19) United States
(12) Patent Application Publication
(10) Pub. No.: US 2021/0018034 A1
(43) Pub. Date: Jan. 21, 2021

(54) OLIVE-SHAPED ASYMMETRIC BIDIRECTIONAL TAPERED THREAD CONNECTION PAIR HAVING LARGE LEFT TAPER AND SMALL RIGHT TAPER

(71) Applicant: AMICUS VERITATIS MACHINERY CO., LTD., Taizhou (CN)

(72) Inventor: Yihua YOU, TAIZHOU (CN)

(73) Assignee: AMICUS VERITATIS MACHINERY CO., LTD.

(21) Appl. No.: 17/031,790

(22) Filed: Sep. 24, 2020

Related U.S. Application Data
(63) Continuation of application No. PCT/CN2019/081371, filed on Apr. 4, 2019.

(30) Foreign Application Priority Data
Apr. 7, 2018 (CN) 201810303106.7

(51) Int. Cl. F16B 39/30; F16B 33/02; F16B 35/04

(52) U.S. Cl. CPC F16B 39/30; F16B 35/04; F16B 33/02

(57) ABSTRACT

The disclosure belongs to the technical field of general technology of devices, and relates to an olive-shaped asymmetric bidirectional tapered thread connection pair having a large left taper and a small right taper, solving the problems of poor self-positioning and self-locking properties of the existing thread. An internal thread (6) is a bidirectional tapered hole (41) (non-entity space) on the inner surface of the cylindrical body (2), an external thread (9) is a bidirectional truncated cone body (71) (material entity), the complete unit threads are both helical olive-like (93) shaped special bidirectional tapered bodies which have a left taper (95) being a right taper (96) and is large in the middle and small in two ends.

### CROSS-REFERENCE TO RELATED APPLICATIONS

This application is a continuation of International Patent Application No. PCT/CN2019/081371 with a filing date of Apr. 4, 2019, designating the United States, now pending, and further claims priority to Chinese Patent Application No. 201810303106.7 with a filing date of Apr. 7, 2018. The content of the aforementioned applications, including any intervening amendments thereto, are incorporated herein by reference.

### TECHNICAL FIELD

The disclosure belongs to the field of general technology of devices, and particularly relates to an olive-shaped bidirectional tapered thread connection pair having a large left taper and a small right taper, namely an olive-like (left taper is larger than right taper) shaped asymmetric bidirectional tapered thread connection pair (hereinafter referred to as “olive-like shaped asymmetric bidirectional tapered thread connection pair”).

### BACKGROUND OF THE PRESENT INVENTION

The invention of threads has a profound impact on the progress of human society. The thread is one of the most basic industrial technologies. It is not a specific product, but a key common technology in the industry. Its technical performance must be embodied by using the specific product as an application carrier, and the thread is widely used in all walks of life. The existing thread technology has a high standardization level, a mature technological theory and long-term practical application. If being used to fasten, the thread is a fastening thread; if being used to seal, the thread is a seal thread; if being used to drive, the thread is a transmission thread. According to thread terms in national standard: “thread” refers to tooth bodies having the same tooth shape and continuously protruded along a helical line on the cylindrical or conical surface; “tooth body” refers to a material entity between adjacent tooth sides. This is a definition of a thread that is globally agreed.

Modern threads are derived from Whitworth threads in England in 1841. According to the theory of the modern thread technology, the basic self-locking condition of the thread is that an equivalent friction angle should not be less than a lead angle. This is an understanding of the modern thread on the thread technology based on its technical principle-“bevel principle”, and has become an important theoretical basis for the modern thread technology. Steven theoretically explained the bevel principle at the earliest, he studied and found object balance conditions on the bevel and a parallelogram law of force synthesis. In 1586, he put forward a famous bevel law: the gravity of an object placed on the bevel along the bevel direction is proportional to the sine of the inclined angle. The bevel refers to a smooth plane which is inclined to a horizontal plane. The helical surface is the deformation of the “bevel”. The thread is like the bevel wrapped outside the cylindrical body, the smoother the bevel is, the greater the mechanical benefits are (see FIG. 8) (Jingshan Yang, Xiuya Wang, Discussion On The Principle Of Screws, Gauss Arithmetic Research).

The “bevel principle” of the modern thread is a bevel slider model established based on a bevel law (see FIG. 9). It is believed that under the conditions of static load and little temperature change, when the lead angle is less than or equal to the equivalent friction angle, a thread pair has self-locking conditions. The lead angle (see FIG. 10) is also known as a thread lead angle, namely an included angle between the tangent line of the helical line on a cylinder having a middle diameter and a plane perpendicular to the thread axis, which affects the self-locking and loosening prevention of the thread. The equivalent friction angle is a corresponding friction angle when different friction forms are finally transformed into the most common bevel slider form. Generally speaking, in a bevel slider model, when the bevel is inclined to a certain angle, the frictional force of the slider at this moment is just equal to the component of gravity along the bevel. At this moment, the object is just in a stress balance state. At this moment, the inclined angle of the bevel is called the equivalent friction angle.

American engineers invented a wedge-shaped thread in the middle of last century, and its technical principle still followed the “bevel principle”. The invention of the wedge-shaped thread is inspired by “wood wedge”. Specifically, the structure of the wedge-shaped thread has a wedge-shaped bevel which has an included angle of 25°-30° with the thread axis at the tooth bottom of the internal thread (i.e., nut thread) of the triangular thread (commonly known as common thread). In engineering practice, 30° wedge-shaped bevel is actually used. For along time, people study and solve the problem of thread loosening prevention from the technical level and technical direction namely thread tooth profile angles. The wedge-shaped thread technology is no exception, which is a specific application of a wedge technology.

There are many types and forms of threads that are all tooth-shaped threads, which is determined by the technical principle namely bevel principle. Specifically, a thread formed on the surface of a cylinder is called a cylindrical thread, a thread formed on the surface of a cone is called a conical thread, and a thread formed on the surface of the end surface such as the cylinder or truncated cone body is called a plane thread; a thread formed on the surface of the outer circle of the body is called an external thread, a thread formed on the surface of the inner round hole of the body is called an internal thread, and a thread formed on the surface of the end surface of the body is called an end surface thread; a thread whose screwing direction and lead angle direction conform to a left-hand rule is called a left-hand thread, and a thread whose screwing direction and lead angle direction conform to a right-hand rule is called a right-hand thread; a thread having only one helical line in the same cross section of the body is called a single thread, a thread having two helical lines is called a double thread, and a thread having multiple helical lines is called multiple thread. A thread whose cross section is triangular is called a triangular thread, a thread whose cross section is trapezoidal is called a trapezoidal thread, a thread whose cross section is rectangular is called a rectangular thread, and a thread whose cross section is zigzag is called a sawtooth thread.

However, the existing thread has the problems of low connection strength, weak self-positioning capability, poor self-locking property, small bearing strength value, poor stability, poor compatibility, poor reusability, high temperature and low temperature and the like. Typical problems are that bolts or nuts using the modern thread technology have the defect of easy loosening. With the frequent vibration or shaking of the equipment, the bolts and nuts are loosened or even fall off, seriously, safety accidents easily occur.

### SUMMARY OF PRESENT INVENTION

Any technical theory has its theoretical assumption background, and there is no exception for threads. With the scientific and technical development, connection destruction is not pure linear load, even non-static and non room-temperature environment. There are linear loads, nonlinear loads and even the superposition of the linear loads and nonlinear loads, resulting in more complex failure loads with complex application work condition. Based on this understanding, aiming at the above problems, the objective of the disclosure is to provide an olive-like shaped asymmetric bidirectional tapered thread connection pair which is reasonable in design, simple in structure, good in connection performance and locking performance.

In order to achieve the above objective, the disclosure adopts the following technical solution: the olive-like (left taper is larger than right taper) shaped asymmetric bidirectional tapered thread connection pair is a thread connection pair formed by an asymmetric bidirectional tapered external thread and an asymmetric bidirectional internal thread to be used, and is a special thread pair technology combining technical features of conical pairs and helical movement. The bidirectional tapered thread is a thread technology combining technical features of a bidirectional tapered body and a helical structure. The bidirectional tapered body is composed of two single tapered bodies, that is, is bi-directionally composed of two single tapered bodies having opposite left and right taper directions and different tapers and having the taper of the left single tapered body being larger than that of the right single tapered body. The bidirectional tapered body is helically distributed on the outer surface of the columnar body to form the external thread and/or the above bidirectional tapered body is helically distributed on the inner surface of the cylindrical body to form the internal thread. No matter which the internal thread or the external thread, its complete unit thread is an olive-like shaped special bidirectional tapered geometry which is large in the middle and small in two ends and has a left taper being larger than a right taper.

In the olive-like shaped asymmetric bidirectional tapered thread connection pair, the olive-like shaped asymmetric bidirectional tapered thread can be defined as “cylindrical or conical surface is provided with asymmetric bidirectional tapered hole having specified left taper and right taper, opposite left taper and right taper directions and left taper being larger than right taper (or asymmetric bidirectional truncated cone body) and a helical olive-like shaped special bidirectional tapered geometry which is continuously and/or discontinuously distributed along the helical line and is small in two ends and large in the middle”. For reasons such as manufacturing, the head and the tail of the asymmetric bidirectional tapered thread may be incomplete bidirectional tapered geometries. Different from the modern thread technology, on appellation, the quantity of the complete unit thread and/or incomplete unit thread is that the bidirectional tapered thread does not use “tooth number” as an unit and uses “number of sections” as the unit, that is, is not called several tooth of threads, and called several sections of threads. The change of the quantity of threads in terms of appellation occurs based on change of thread technology connotation. The thread technology has been changed from an engagement relationship between the internal thread and the external thread of the original modern thread into a cohesion relationship between the internal thread and the external thread of the bidirectional tapered thread.

The olive-like shaped asymmetric bidirectional tapered thread connection pair includes a bidirectional truncated cone body helically distributed on the outer surface of the columnar body and a bidirectional tapered hole helically distributed on the inner surface of the cylindrical body, that is, the internal thread and the external thread which are in mutual thread fit, the internal thread is presented by a helical bidirectional tapered hole and exists in a form of “non-entity space”, and the external thread is presented by a helical special tapered body and exists in a form of “material entity”, and the non-entity space refers to a space environment capable of accommodating the above material entity. The internal thread is a containing member, and the external thread is a contained member. The work state of the thread is as follows: the internal threads and the external threads are formed by screwing and sleeving bidirectional tapered geometries for cohesion till bidirectional bearing at one side or simultaneous bidirectional bearing at left and right sides or till fixed-diameter interference fit, whether simultaneous bidirectional bearing occurs at two sides is related to actual application working conditions, that is, the bidirectional truncated cone bodies are received in the bidirectional tapered holes one by one, that is, the internal threads are cohered with corresponding external threads one by one.

The thread connection pair is a thread pair formed by a cone pair constituted by mutual fit between a helical outer conical surface and a helical inner conical surface. The outer conical surface of the bidirectional tapered thread outer cone and the inner conical surface of the inner cone are both bidirectional conical surfaces. When the bidirectional tapered threads constitute the thread connection pair, the combination surface of the inner conical surface and the outer conical surface is a bearing surface, that is, the conical surface is used as the bearing surface to realize connection technical performance. The self-locking property, self-positioning property, reusability, fatigue resistance and other capabilities of the thread pair mainly depend on the conical surfaces and tapers of the cone pairs constituting the olive-like shaped asymmetric bidirectional tapered thread connection pair, namely the conical surfaces and tapers of the internal and external threads. The thread connection pair is a non-tooth thread.

Different from an unidirectional force distributed on the bevel and exhibited by the existing thread bevel principle and an engagement relationship between an internal tooth body and an external tooth body of the internal and external threads, whether the bidirectional tapered body of the olive-like shaped asymmetric bidirectional tapered thread connection pair is distributed at the left side or the right side, when passing through the cross section of the cone axis, the single tapered body at any side is bi-directionally composed of two tessellation lines, namely in a bidirectional state. The tessellation line is an intersecting line formed by the conical surface and a plane through which the cone axis passes. An axial force and a counter-axial force are exhibited by the cone principle of the olive-like shaped asymmetric tapered thread connection pair, both of them are synthesized by bidirectional forces. The axial force and the corresponding counter-axial force are opposite, the internal thread and the external thread are in cohesion relationship, that is, when the thread pair is formed, the external thread is cohered by the internal thread, that is, tapered holes (inner cones) cohere corresponding tapered bodies (outer cones) till fixed-diameter fit so as to realize self positioning or till fixed-diameter interference fit contact so as to realize self locking, that is, self locking or self positioning of the inner cone and the outer cone is realized through cohesion of the tapered hole and the truncated cone body and then self locking or self positioning of the thread pair, rather than a fact that the thread connection pair is constituted by the internal thread and the external thread of the traditional thread through mutual abutting of tooth bodies to realize thread connection property.

A self-locking force can be generated when the cohesion process of the internal thread and the external thread reaches a certain condition. The self-locking force is generated by a pressure formed between the axial force of the inner cone and the counter-axial force of the outer cone, that is, when the inner cone and the outer cone constitute a cone pair, the inner conical surface of the inner cone coheres the outer conical surface of the outer cone, and the inner conical surface is in close contact with the outer conical surface. The axial force of the inner cone and the counter-axial force of the outer cone are concepts of a force which is unique to a bidirectional tapered thread technology namely a cone pair technology.

The inner cone exists in a form similar to shaft sleeve. Under the action of external load, the inner cone body generates the axial force pointing to or pressing against the cone axis. The axial force is bi-directionally synthesized by a pair of centripetal forces that are distributed in a mirror image with the cone axis as a center and respectively perpendicular to the two tessellation lines of the cone, that is, when passing through the cross section of the cone axis, the axial force is composed of two centripetal forces that are bi-directionally distributed at two sides of the cone axis in a form of mirror image with the cone axis as the center and respectively perpendicular to two tessellation lines of the cone and point to or press against the common point of the cone axis and when the above cone and the helical structure are synthesized into a thread and applied to the thread pair, when passing through the cross section of the thread axis, the above axial force is composed of two centripetal forces that are bi-directionally distributed at two sides of the thread axis in a form of mirror image and/or mirror-like image with the thread axis as the center and respectively perpendicular to the two tessellation lines of the cone and point to or press against the common point of the thread axis. The axial force is thickly distributed on the cone axis and/or the thread axis in an axial and circumferential manner, the axial force corresponds to one axial force angle, the included angle of the two centripetal forces constituting the axial force constitutes the above axial force angle, the axial force angle depends on the taper of the cone body namely a taper angle.

The outer cone exists in a form similar to shaft, and has a strong ability to absorb various external loads. The outer cone generates a counter-axial force opposite to each axial force of the inner cone. The counter-axial force is bi-directionally synthesized by a pair of counter centripetal forces which are distributed in a mirror image with the cone axis as the center and respectively perpendicular to the two tessellation lines of the cone, that is, when passing through the cross section of the cone axis, the counter-axial force is composed of two counter centripetal forces which are bi-directionally distributed at two sides of the cone axis in a mirror image with the cone axis as the center and respectively perpendicular to the two tessellation lines of the cone or point to or press against the inner conical surface and when the above cone and the helical structure are synthesized into the thread and applied to the thread pair, when passing through the cross section of the thread axis, the above counter-axial force is composed of two counter centripetal forces which are bi-directionally distributed at two sides of the cone in a mirror image and/or mirror-like image with the thread axis as the center and respectively perpendicular to two tessellation lines of the cone and point to or press against the inner conical surface of the internal thread through the common points and/or similar common points of the cone axis. The counter-axial force is densely distributed on the cone axis and/or the thread axis in an axial and circumferential manner, the counter-axial force corresponds to one counter-axial force angle, the included angle between the two counter centripetal forces constituting the counter-axial force constitutes the above counter-axial force angle, and the counter-axial force angle depends on the taper of the cone, namely taper angle.

The axial force and the counter-axial force are generated when the inner and outer cones of the cone pair are in effective contact, that is, there is always a pair of corresponding and opposite axial force and counter-axial force in the effective contact process of the inner and outer cones of the cone pair. Both of the axial force and the counter-axial force are bidirectional forces, rather than unidirectional forces, which are distributed in mirror image with the cone axis and/or the thread axis as the center. The cone axis and the thread axis are coincident axes, namely the same axis and/or approximately the same axis. The counter-axial force and the axial force are inversely collinear, and the counter-axial force and the axial force are inversely collinear and/or approximately inversely collinear when the above cone and the helical structure are synthesized into the thread and constitute the thread pair. Through cohesion of the inner cone and the external cone till interference, the axial force and the counter-axial force generate the pressure on the contact surface of the inner conical surface and the outer conical surface and are densely and uniformly distributed on the contact surface of inner and outer conical surfaces in the axial and circumferential manner. When the cohesion movement of the inner cone and the outer cone proceeds all the time till the cone pair reaches interference fit, the generated pressure combines the inner cone with the outer cone, that is, the above pressure can allow the cohesion of the inner cone and the outer cone to form a similar overall structure and the inner and outer cones do not fall off under the action of gravity because the position direction of the above similar overall structure randomly changes after the external force disappears. The cone pair generates self locking, that is, the thread pair generates self locking. Such the self-locking property has a certain limited resisting action on other external loads which may lead to mutual separation of the inner and outer cones except gravity. The cone pair also has self-positioning property allowing the mutual fit of the inner cone and the outer cone, but not any axial force angle and/or counter-axial force angle can allow the cone pair to generate self locking and self positioning.

When the axial force angle and/or the counter-axial force angle is less than 180° and greater than 127°, the cone pair has self-locking property; when the axial force angle and/or the counter-axial force angle is infinitely close to 180°, the self-locking property of the cone pair is optimal and the axial bearing capacity of the cone pair is the weakest; when the axial force angle and/or the counter-axial force angle is equal to or less than 127° and greater than 0°, the cone pair is in the weak self-locking area and/or non-self-locking area; when the axial force angle and/or the counter-axial force angle changes in a trend of being infinitely close to 0°, the self-locking property of the cone pair changes in a trend of attenuation till the cone pair completely has no self-locking capacity, and the axial bearing capacity changes in a trend of enhancement till the axial bearing capacity is the strongest.

When the axial force angle and/or the counter-axial force angle is, less than 180° and greater than 127°, the cone pair is in a strong self-positioning state and the strong self positioning of the inner and outer cones is easily achieved; when the axial force angle and/or the counter-axial force angle is infinitely close to 180°, the self positioning capability of the inner and outer cones of the cone pair is the strongest; when the axial force angle and/or the counter-axial force angle is equal to or less than 127° and greater than 0°, the cone pair is in a weak self-positioning state; when the axial force angle and/or the counter-axial force angle changes in a trend of being infinity close to 0°, the mutual self-positioning ability of the inner and outer cones of the cone pair changes in a trend of attenuation till they completely have no self-positioning capability.

Compared with an irreversible single-side bidirectional containing-contained relationship borne by only single side of the conical surface of the unidirectional tapered thread of the single tapered body invented previously by the applicant, reversible left-right bidirectional containing of the bidirectional tapered thread of the double tapered body of this bidirectional tapered thread connection pair can be left bearing of the conical surface and/or right bearing of the conical surface and/or left bearing and right bearing of the conical surface and/or simultaneous left and right bearing of the conical surface, even the disordered freedom degree between the tapered hole and the truncated cone body is limited, helical movement allows the asymmetric bidirectional tapered thread connection pair to obtain the necessary ordered freedom degree, so as to effectively combine the technical features of the cone pair and the thread pair to form a new thread technology.

When the asymmetric bidirectional tapered thread connection pair is in use, the conical surface of the bidirectional truncated cone body of the bidirectional tapered thread external thread and the bidirectional tapered hole conical surface of the bidirectional tapered thread internal thread are in mutual fit.

The bidirectional tapered body of the conical pair constituting the olive-like shaped asymmetric bidirectional tapered thread connection pair, namely truncated cone body and/or tapered hole can not necessarily achieve the self locking and/or self positioning of the thread connection pair at any taper or any taper angle, and the asymmetric bidirectional tapered thread connection pair has the self-locking property and self-positioning property as long as the inner and outer cone bodies must reach a certain taper or a certain taper angle. The taper includes the left taper and right taper of the internal and external thread bodies, the taper angle includes the left taper angle and the right taper angle of the internal and external thread bodies, the internal thread and the external thread of the asymmetric bidirectional tapered thread constituting the olive-like shaped asymmetric bidirectional tapered thread connection pair have a left taper being larger than a right taper, the left taper corresponds to the left taper angle namely a first taper angle α1, preferably, 0°<first taper angle α1<53°, preferably, the first taper angle α1 is 2° ˜40°, for individual special fields, preferably, 53°≤first taper angle α1<180°, preferably, the first taper angle α1 is 53°˜90°; the right taper corresponds to the right taper angle namely the second taper angle α 2, preferably, 0°<the second taper angle α2<53°, preferably, the second taper angle α2 is 2° ˜40°.

The above individual special fields refer to thread connection application fields which have low self-locking property requirement and even need no self-locking property and/or weak self-positioning property and/or high axial bearing force requirement and/or transmission connection must be set.

In the olive-like shaped asymmetric bidirectional tapered thread connection pair, the external thread is arranged on the outer surface of the columnar body, the outer surface of the columnar body is provided with helically distributed truncated cone body including an asymmetric bidirectional truncated cone body. The columnar body can be solid or hollow and includes a cylindrical and/or non-cylindrical workpieces and objects that need to be machined with threads on their outer surfaces. The outer surface includes an outer surface geometrical shape, such as a cylindrical surface and a non-cylindrical surface such as the conical surface.

In the olive-like shaped bidirectional tapered thread connection pair, the asymmetric bidirectional truncated cone body namely external thread is formed by oppositely jointing two symmetrical lower bottom surfaces of two truncated cone bodies, wherein the two truncated cone bodies have identical lower bottom surfaces and upper top surfaces, but different taper heights; wherein the upper top surfaces of the two truncated cone bodies are located at two ends of the bidirectional truncated cone body, and are respectively jointed with the upper top surfaces of the adjacent bidirectional truncated cone bodies. The external thread includes a truncated cone body first helical conical surface and a truncated cone body second helical conical surface as well as an outer helical line. In the cross section through which the thread axis passes, the complete single asymmetric bidirectional tapered external thread of the formed asymmetric bidirectional tapered external thread is an olive-like shaped special bidirectional tapered geometry which is large in the middle and small at the two ends and has the taper of the left truncated cone body being larger than that of the right truncated cone body. The bidirectional truncated cone body includes a bidirectional truncated cone body conical surface. The included angle formed by two tessellation lines of the left conical surface namely truncated cone body first helical conical surface is the first taper angle α1. The truncated cone body first helical conical surface forms the left taper and is in left-direction distribution, and the included angle between the two tessellation lines of the right conical surface namely truncated cone body second helical conical surface is the second taper angle α2. The truncated cone body second helical conical surface forms the right taper and is in right-direction distribution. The taper directions corresponding to the first taper angle α1 and the second taper angle α2 are opposite. The tessellation line refers to an intersecting line of the conical surface and the plane through which the cone axis passes. A shape formed by the truncated cone body first helical conical surface and the truncated cone body second helical conical surface is the same as a shape of a helical outer flank of the rotating body, wherein the rotating body is formed by the right-angled trapezoid union being rotated around the right-angled side of the right-angled trapezoid union, and, at the same time, the right-angled trapezoid union axially moves at a constant speed along the central axis of the columnar body; wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the columnar body. The right-angled trapezoid union refers to a special geometry in which the bottom sides are the same and upper bottom sides are the same but right-angled sides are different, and the lower bottom sides of two right-angled trapezoids are symmetric and oppositely jointed, and the upper bottom sides are respectively at the two ends of the right-angled trapezoid union.

In the olive-like shaped asymmetric bidirectional tapered thread connection pair, the internal thread is arranged on the inner surface of the cylindrical body, the inner surface of the cylindrical body is provided with helically distributed tapered hole, the tapered hole includes an asymmetric bidirectional tapered hole. The cylindrical body includes a cylindrical and/or non-cylindrical workpieces and objects that need to be machined with internal threads on their outer surfaces. The inner surface includes an inner surface geometrical shape, such as a cylindrical surface and a non-cylindrical surface such as the conical surface.

In the olive-like shaped bidirectional tapered thread connection pair, the asymmetric bidirectional tapered hole namely internal thread is formed by oppositely jointing two symmetrical lower bottom surfaces of two tapered holes, wherein the two tapered holes have identical lower bottom surfaces and upper top surfaces, but different taper heights; wherein the upper top surfaces of the two tapered holes are located at two ends of the bidirectional tapered holes, and are respectively jointed with the upper top surfaces of the adjacent bidirectional tapered holes. The internal thread includes a tapered hole first helical conical surface and a tapered hole second helical conical surface as well as an inner helical line. In the cross section through which the thread axis passes, the complete single-pitch asymmetric bidirectional tapered internal thread of the formed asymmetric bidirectional tapered internal thread is an olive-like shaped special bidirectional tapered geometry which is large in the middle and small at the two ends and has the taper of the left tapered hole being larger than that of the right tapered hole. The bidirectional tapered hole includes a bidirectional tapered hole conical surface. The included angle formed by two tessellation lines of the left conical surface namely tapered hole first helical conical surface is the first taper angle α1. The tapered hole first helical conical surface forms the left taper and is in left-direction distribution, and the included angle between the two tessellation lines of the right conical surface namely tapered hole second helical conical surface is the second taper angle α2. The truncated cone body second helical conical surface forms the right taper and is in right-direction distribution. The taper directions corresponding to the first taper angle α1 and the second taper angle α2 are opposite. The tessellation line refers to an intersecting line of the conical surface and the plane through which the cone axis passes. A shape formed by the tapered hole first helical conical surface and the tapered hole second helical conical surface of the bidirectional tapered hole is the same as a shape of a helical outer flank of a rotating body, wherein the rotating body is formed by two bevels of a right-angled trapezoid union being rotated around a right-angled side of the right-angled trapezoid union, and, at the same time, the right-angled trapezoid union axially moves at a constant speed along a central axis of the cylindrical body; wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the cylindrical body. The right-angled trapezoid union refers to a special geometry in which the bottom sides are the same and upper bottom sides are the same but right-angled sides are different, and the lower bottom sides of two right-angled trapezoids are symmetric and oppositely jointed, and the upper bottom sides are respectively at the two ends of the right-angled trapezoid union.

In the above olive-like shaped asymmetric bidirectional tapered thread connection pair, there are sharp angles and/or non-sharp angles or other connection forms are respectively formed at the junction of the two adjacent helical conical surfaces of the external thread and at the junction of two adjacent helical conical surfaces of the internal thread, and the sharp angle, relative to the non-sharp angle, refers to a structure form which is purposely subjected to non-sharp angle processing.

In the above olive-like shaped asymmetric bidirectional thread connection pair, when the connection form is the sharp angle, at the junction between the truncated cone body first helical conical surface and the truncated cone body second helical conical surface of the same helical bidirectional truncated cone body, the large diameter of the external thread is connected by the outer sharp angle structure, and a helically distributed outer helical line is formed; at the junction between the truncated cone body first helical circular conical surface of the same helical bidirectional truncated cone body and the truncated cone body second helical conical surface of the adjacent bidirectional truncated cone body and/or at the junction between the truncated cone body second helical conical surface of the same helical bidirectional truncated cone body and the truncated cone body first helical conical surface of the adjacent bidirectional truncated cone body, the small diameter of the external thread is connected by using the inner sharp angle structure and a helically distributed outer helical line is formed; at the junction between the tapered hole first helical conical surface of the same helical bidirectional tapered hole and the tapered hole second helical conical surface, the large diameter of the internal thread is connected by using the inner sharp angle shape and a helically distributed inner helical line is formed; at the junction between the tapered hole first helical conical surface of the same helical bidirectional tapered hole and the tapered hole second helical conical surface of the adjacent bidirectional tapered hole and/or at the junction between the tapered hole second helical conical surface of the same helical bidirectional tapered hole and the tapered hole first helical conical surface of the adjacent bidirectional tapered hole, the small diameter of the internal thread is connected by using the outer sharp angle structure and a helically distributed inner helical line is formed. The thread structure is more compact, higher in strength, large in bearing force, has good mechanical connection, locking property, sealing property and more spacious tapered thread processing physical space.

In the above olive-like shaped asymmetric bidirectional tapered thread connection pair, when the connection form is the non-sharp angle, at the junction between the truncated cone body first helical conical surface and the truncated cone body second helical conical surface of the same helical bidirectional truncated cone body, the large diameter of the external thread is connected by the external non-sharp angle structure, and a helically distributed external helical structure such as flat or arc is formed; at the junction between the truncated cone body first helical circular conical surface of the same helical bidirectional truncated cone body and the truncated cone body second helical conical surface of the adjacent bidirectional truncated cone body and/or at the junction between the truncated cone body second helical conical surface of the same helical bidirectional truncated cone body and the truncated cone body first helical conical surface of the adjacent bidirectional truncated cone body, the small diameter of the external thread is connected by using the inner non-sharp angle structure and a helically distributed external helical structure such as groove or arc is formed; at the junction between the tapered hole first helical conical surface of the same helical bidirectional tapered hole and the tapered hole second helical conical surface of the same helical bidirectional tapered hole, the large diameter of the internal thread is connected by using the inner non-sharp angle and a helically distributed inner helical structure such as groove or arc is formed; at the junction between the tapered hole first helical conical surface of the same helical bidirectional tapered hole and the tapered hole second helical conical surface of the adjacent bidirectional tapered hole and/or at the junction between the tapered hole second helical conical surface of the same helical bidirectional tapered hole and the tapered hole first helical conical surface of the adjacent bidirectional tapered hole, the small diameter of the internal thread is connected by using the outer non-sharp angle and a helically distributed inner helical structure such as flat or arc is formed. The non-outer sharp angle refers to a geometry shape whose section is plane or arc, the non-inner sharp angle refers to a geometry shape whose section is groove or arc, which can prevent interference generated when the internal thread and the external thread are screwed, can store oil and dirt. According to actual application situations, the small diameter of the external thread and the large diameter of the internal thread are processed by using the groove or arc structure, the large diameter of the external thread and the small diameter of the internal thread are processed by using sharp angle structure and/or the large diameter of the external thread and the small diameter of the internal thread is processed by using the plane or arc structure, and the small diameter of the external thread and the large diameter of the internal thread are processed by using sharp angle structure and/or the small diameter of the external thread and the large diameter of the internal thread is processed by using the groove or arc structure, while the large diameter of the external thread and the small diameter of the internal thread is processed by using the plane or arc structure, or the like.

When being in transmission connection, the olive-like shaped asymmetric bidirectional tapered thread connection pair is in bidirectional bearing through screw connection of the bidirectional tapered internal thread namely bidirectional tapered hole and bidirectional tapered external thread namely the bidirectional truncated cone body. There must be a clearance between the bidirectional tapered external thread and the bidirectional tapered internal thread. If there is an oily medium between the internal thread and the external thread for lubrication, a bearing oily film will be easily formed, and the clearance is beneficial to formation of the bearing oily film. The olive-like shaped asymmetric bidirectional tapered thread connection pair is applied to transmission connection, which is equivalent to a group of sliding bearing pairs composed of one pair and/or several pairs of sliding bearings, that is, each bidirectional tapered internal thread bi-directionally receives a corresponding traditional external thread so as to form a pair of sliding bearings. The pitch number of the formed sliding bearings is adjusted according to application working conditions, that is, the bidirectional tapered internal thread and the traditional external thread are effectively and bi-directionally jointed, that is, the pitch number of the containing-contained threads that are effectively and bi-directionally in contact cohesion is designed according to application working conditions, and the directional truncated cone body is received through the bidirectional tapered hole and is positioned in multiple directions such as radial direction, axial direction, angular direction and circumferential direction. Preferably, the bidirectional truncated cone body is received through the bidirectional tapered hole and mainly positioned in radial and circumferential directions with the help of assistant positioning in axial and angular directions, and then the multi-directional positioning of inner and outer cones is formed till the conical surface of the bidirectional tapered hole and the conical surface of the bidirectional truncated cone body are cohered to realize the self positioning or till self locking is generated by means of fixed-diameter interference contact, so as to form a special cone pair and thread pair synthesis technology to ensure the accuracy, efficiency and reliability of the transmission connection of the tapered thread technology, especially the asymmetric bidirectional tapered thread connection pair.

When the olive-like shaped asymmetric bidirectional tapered thread connection pair is in fastening connection and in seal connection, its technical performance is realized by screw connection of the bidirectional tapered hole and the directional truncated cone body, that is, the truncated cone body first helical conical surface and the tapered hole first helical conical surface are in fixed-diameter interference and/or the truncated cone body second helical conical surface and the tapered hole second helical conical surface are in fixed-diameter interference. According to application working conditions, bearing in one direction and/or simultaneous and respectively bearing in two directions are achieved, that is, the inner cone and the outer cone of the bidirectional truncated cone body and the bidirectional tapered hole are in inner diameter/outer diameter centring under the guidance of the helical line till the tapered hole first helical conical surface and the truncated cone body first helical conical surface are cohered to reach bearing in one direction or simultaneous and respective bearing in two directions till fixed-diameter fit or till fixed-diameter interference contact and/or the tapered hole second helical conical surface and the truncated cone body second helical conical surface are cohered to reach bearing in one direction or simultaneous and respective bearing in two direction till fixed-diameter fit or till fixed-diameter interference contact, that is, the multi-directional positioning of the inner and outer cones is formed through the self locking as well as radial, axial, angular and circumferential positioning of the bidirectional inner and outer cones of the tapered external thread received by the bidirectional inner cone of the tapered internal thread, preferably, through the bidirectional truncated cone body received in the bidirectional tapered hole and main positioning in radial and circumferential directions with the help of assistant positioning in axial and angular directions, the multi-directional positioning of the inner and outer cones is formed till the bidirectional tapered hole conical surface and the bidirectional truncated cone body are cohered to realize self positioning till fixed-diameter interference to generate self locking, so as to form a special cone pair and thread pair synthesis technology to ensure the effectiveness and reliability of the tapered thread technology, especially the bolt and nut of the bidirectional tapered thread, thereby realizing technical performances of mechanical mechanisms, such as connection, locking, loosening prevention, bearing, fatigue and sealing.

Therefore, transmission accuracy, effectiveness, bearing capability, self-locking force, loose prevention capability, sealing property and other technical properties of the mechanical mechanism of the olive-like shaped asymmetric bidirectional tapered thread connection pair are related to the truncated cone body first helical conical surface and the formed left taper namely corresponding first taper angle α1, the truncated cone body second helical conical surface and the formed right taper namely corresponding second taper angle α2, and the tapered hole first helical conical surface and the formed left taper namely first taper angle α1 and the tapered hole second helical conical surface and the formed right taper namely second tapered angle α2. The material friction coefficients, machining qualities and application working conditions of the columnar body and the cylindrical body can also affect cone fit to a certain extent.

In the above olive-like shaped asymmetric bidirectional tapered thread connection pair, when the right-angled trapezoid union rotates a circle at a constant speed, the axial movement distance of the right-angled trapezoid union is at least double a length of the sum of the right-angled sides of two right-angled trapezoids with the same lower bottom sides and the same upper bottom sides but different right-angled sides. This structure ensures that the truncated cone body first helical conical surface and the truncated cone body second helical conical surface as well as the tapered hole first helical conical surface and the tapered hole second conical surface have enough lengths, thus ensuring that the bidirectional truncated cone body conical surface has sufficiently effective contact area and strength as well as efficiency required by helical movement when being matched with the bidirectional tapered hole conical surface.

In the above olive-like shaped asymmetric bidirectional tapered thread connection pair, when the right-angled trapezoid union rotates a circle at a constant speed, the axial movement distance of the right-angled trapezoid union is equal to a length of the sum of right-angled sides of two right-angled trapezoids with the same lower bottom sides and the same upper bottom sides but different right-angled sides. This structure ensures that the truncated cone body first helical conical surface and the truncated cone body second helical conical surface as well as the tapered hole first helical conical surface and the tapered hole second helical conical surface have enough lengths, thus ensuring that the bidirectional truncated cone body conical surface has a sufficiently effective contact area and strength as well as efficiency required by helical movement when being matched with the bidirectional tapered hole conical surface.

In the above olive-like shaped asymmetric bidirectional tapered thread connection pair, both of the truncated cone body first helical conical surface and the truncated cone body second helical conical surface are continuous helical surfaces or non-continuous helical surfaces; both of the tapered hole first helical conical surface and the tapered hole second helical conical surface are continuous helical surfaces or non-continuous helical surfaces. Preferably, here, the truncated cone body first helical conical surface and the truncated cone body second helical conical surface as well as the tapered hole first helical conical surface and the tapered hole second helical conical surface are all continuous helical surfaces.

In the above olive-like shaped asymmetric bidirectional tapered thread connection pair, when the connection hole of the cylindrical body is screwed into the screw-in end of the columnar body, the screw-in direction is required, that is, the connection hole of the cylindrical body cannot be screwed in along the opposite direction. The contact surface of the truncated cone body first helical conical surface and the tapered hole first helical conical surface is a bearing surface and/or interference fit and/or the contact surface of the truncated cone body second helical conical surface and the tapered hole second helical conical surface is the bearing surface and/or interference fit. The included angle namely first taper angle between two tessellation lines of the left conical surface namely first helical conical surface of the internal thread and/or external thread and the included angle namely second taper angle between two tessellation lines of the right conical surface namely second helical conical surface of the internal thread and/or external thread are opposite in direction. The thread connection function is realized through contact and/or interference fit between the first helical conical surface of the internal thread and the first helical conical surface of the external thread and/or through contact and/or interference fit between the second helical conical surface of the internal thread and the second helical conical surface of the external thread.

In the above olive-like shaped asymmetric bidirectional tapered thread connection pair, one end of the columnar body is provided with a head whose size is larger than the outer diameter of the columnar body and/or one end and/or two ends of the columnar body are provided with heads whose sizes are less than the small diameters of the bidirectional tapered external thread of the screw body of the columnar body, and the connection hole is the thread hole formed on the nut. That is, the columnar patent body herein and the head are connected to form a bolt, the bolt which has no head and/or heads at the two ends being smaller than the small diameter of the bidirectional tapered external thread and/or has no thread in the middle and bidirectional tapered external threads respectively at two ends is a double-screw bolt, and the connection hole is formed in the nut.

Compared with the prior art, the olive-like shaped asymmetric bidirectional tapered thread connection pair has the advantages of reasonable design, simple structure, convenient operation, large locking force, large bearing force, good anti-loosing property, high transmission efficiency and accuracy, good mechanical seal effect and good stability, is capable of preventing loosing when connection and has self-locking and self-positioning functions, and fastening and connection functions are achieved through bidirectional bearing or sizing of the cone pair formed by coaxial centring of inner and outer diameters of the inner and outer cones till interference fit.

### DESCRIPTION OF THE DRAWINGS

FIG. 1 is a diagram of an olive-like (left taper is greater than right taper) shaped asymmetric bidirectional tapered thread connection pair in embodiment 1 provided by the disclosure.

FIG. 2 is a structural diagram of an olive-like (left taper is greater than right taper) shaped asymmetric bidirectional tapered thread external thread and a complete unit thread of the external thread in embodiment 1 provided by the disclosure.

FIG. 3 is a structural diagram of a nut body of an internal thread of an olive-like (left taper is greater than right taper) shaped asymmetric bidirectional tapered thread and a complete unit thread of an internal thread in embodiment 1 provided by the disclosure.

FIG. 4 is a structural diagram of an olive-like (left taper is greater than right taper) shaped asymmetric bidirectional tapered thread connection pair in embodiment 2 provided by the disclosure.

FIG. 5 is a structural diagram of an olive-like (left taper is greater than right taper) shaped asymmetric bidirectional tapered thread connection pair in embodiment 3 provided by the disclosure.

FIG. 6 is a structural diagram of an olive-like (left taper is greater than right taper) shaped asymmetric bidirectional tapered thread connection pair in embodiment 4 provided by the disclosure.

FIG. 7 is a structural diagram of an olive-like (left taper is greater than right taper) shaped asymmetric bidirectional tapered thread connection pair in embodiment 5 provided by the disclosure.

FIG. 8 is a diagram of “the thread in the existing thread technology is a bevel on a cylindrical or conical surface” in the background technology of the disclosure.

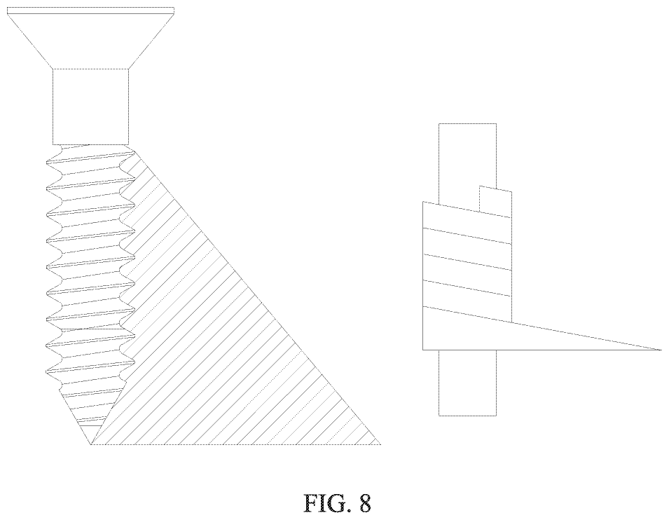

FIG. 9 is a diagram of “bevel slider model based on the existing thread technology principle-bevel principle” in the background technology of the disclosure.

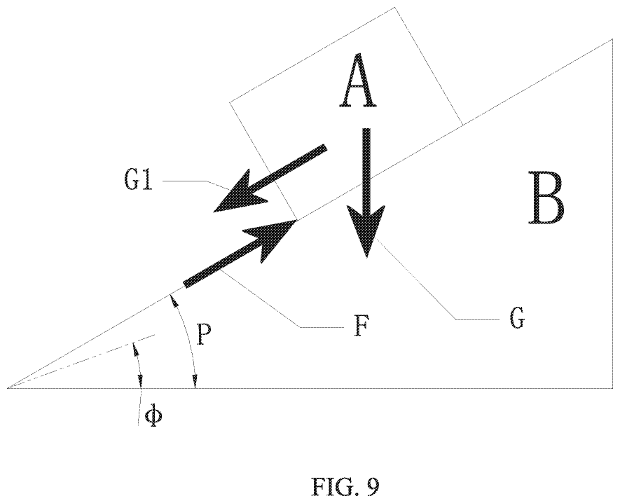

FIG. 10 is a diagram of “lead angle in the existing thread technology” in the background technology of the disclosure.

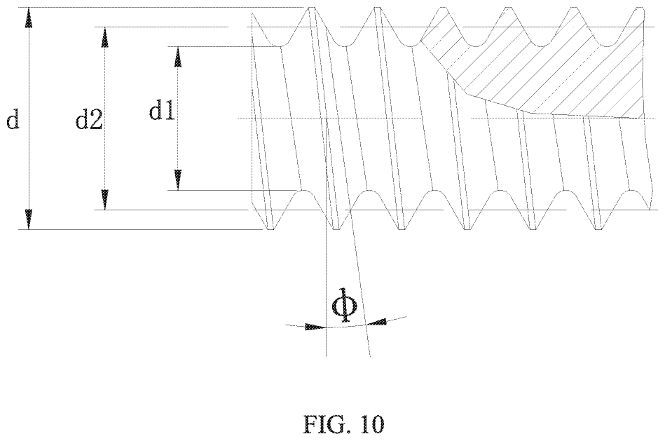

In the figures, tapered thread 1, cylindrical body 2, nut body 21, columnar body 3, screw body 31, tapered hole 4, bidirectional tapered hole 41, bidirectional tapered hole conical surface 42, tapered hole first helical conical surface 421, first taper angle α1, tapered hole second helical conical surface 422, second taper angle α2, inner helical line 5, internal thread 6, bidirectional tapered internal thread groove 61, bidirectional tapered internal thread plane or arc 62, truncated cone body 7, bidirectional truncated cone body 71, bidirectional truncated cone body conical surface 72, truncated cone body helical conical surface 721, first taper angle α1, truncated cone body second helical conical surface 722, second taper angle α2, outer helical line 8, external thread 9, bidirectional tapered external thread groove 91, bidirectional tapered external thread plane or arc 92, olive-like 93, left taper 95, right taper 96, left-direction distribution 97, right-direction distribution 98, thread connection pair and/or thread pair 10, clearance 101, cone axis 01, thread axis 02, slider A on a bevel body, bevel B, gravity G, component G1 of gravity along the bevel, friction force F, lead angle φ, equivalent friction angle P, large traditional external thread diameter d, small traditional external thread diameter d1, and middle traditional external thread diameter d2.

### DETAILED DESCRIPTION OF PREFERRED EMBODIMENTS

The disclosure will be further described in detail in combination with drawings and embodiments below.

### Embodiment 1

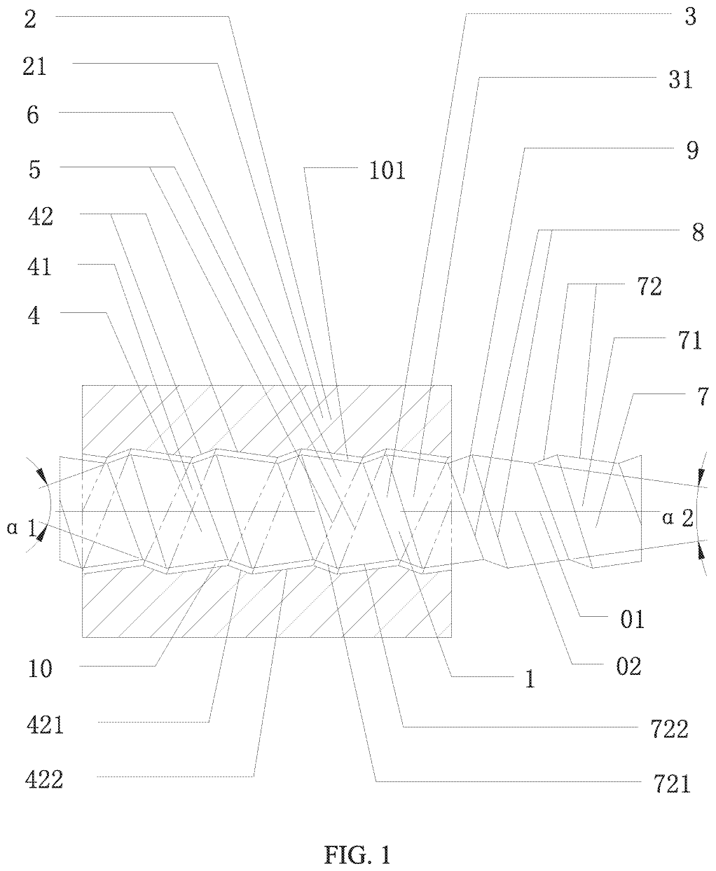

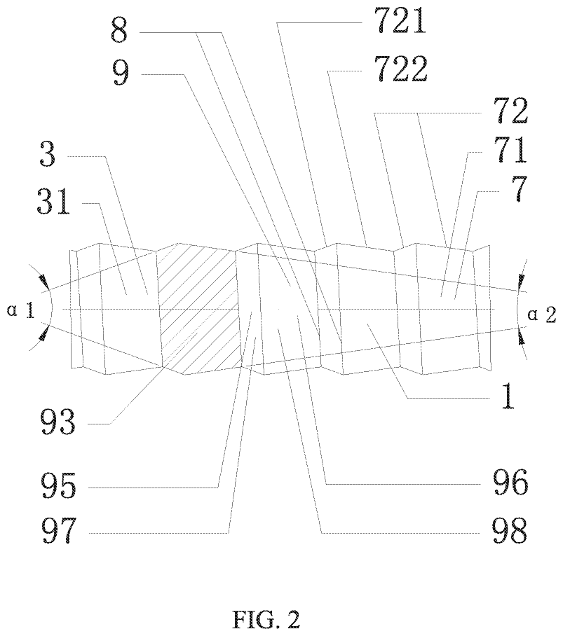

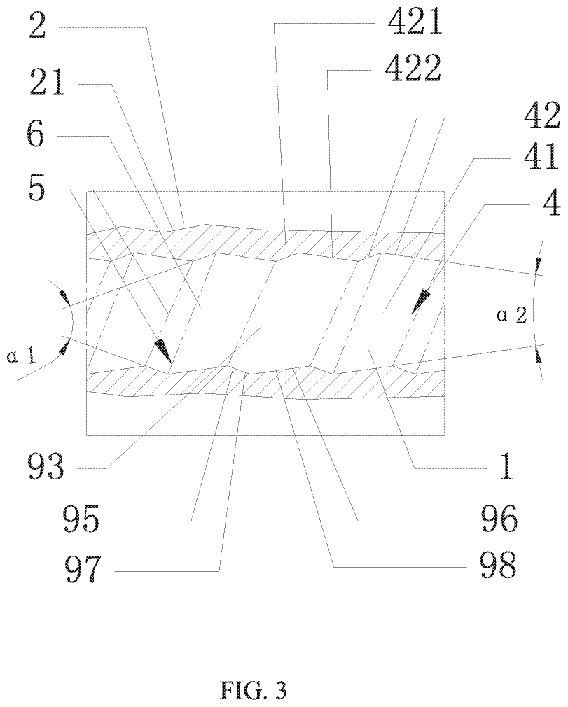

As shown in FIG. 1, FIG. 2 and FIG. 3, the olive-like shaped asymmetric bidirectional tapered thread connection pair includes a bidirectional truncated cone body 71 helically distributed on the outer surface of the columnar body 3 and a bidirectional tapered hole helically distributed on the inner surface of the cylindrical body 2 that is, including an external thread 9 and an internal thread 6 which are in mutual thread fit, the internal thread 6 is presented by the helical bidirectional tapered hole 4 land exists in a form of “non-entity space”, and the external thread 9 is presented by the helical bidirectional truncated cone body 71 and exists in a form of “material entity”. The relationship between the internal thread 6 and the external thread 9 is a containing-contained relationship: the internal thread 6 and the external thread 9 are formed by screwing and sleeving bidirectional tapered geometries one by one to be cohered till interference fit, that is, the bidirectional tapered hole 41 contains the bidirectional truncated cone body 71 pitch by pitch, the disorder freedom degree between the tapered hole 4 and the truncated cone body 7 is bi-directionally contained and limited, and helical movement also allows the asymmetric bidirectional tapered thread connection pair 10 to acquire necessary order freedom degree, so as to effectively synthesize the technical features of the cone pair and the thread pair.

When the olive-like shaped asymmetric bidirectional tapered thread connection pair in this embodiment is used, the bidirectional truncated cone body conical surface 72 and the bidirectional tapered hole conical surface 42 are in mutual fit.

When the truncated cone body 7 and/or tapered hole 4 of the olive-like shaped asymmetric bidirectional tapered thread connection pair in this embodiment reaches a certain taper, that is, the cone constituting the cone pair reaches a certain taper angle, the asymmetric bidirectional tapered thread connection pair 10 has self-locking property and self-positioning property. The taper includes left taper 95 and right taper 96, and the taper angle includes a left taper angle and a right taper angle. The asymmetric bidirectional tapered thread 1 has left taper 95 being larger than right taper 96. The left taper 95 corresponds to the left taper angle namely first taper angle α1, preferably, 0°<first taper angle α1<53°, preferably, the first taper angle α1 is 2°˜40°; for individual special fields, namely connection application fields that do not need self-locking property and/or weak self-locking property and/or high axial bearing capability requirement, preferably, 53° first taper angle α1<180°, preferably, the first taper angle α1 is 53°˜90°; the right taper 96 corresponds to the right taper angle namely second taper angle α2, preferably, 0°<second taper angle α2<53°, preferably, the second taper angle α2 is 2°˜40°.

The external thread 9 is arranged on the outer surface of the columnar body 3, the columnar body 3 is provided with a screw body 31, the outer surface of the screw body 31 is provided with the helically distributed truncated cone body 7, the truncated cone body 7 includes the asymmetric bidirectional truncated cone body 71, the asymmetric bidirectional truncated cone body 71 is an olive-like 93 shaped special bidirectional tapered geometry. The columnar body 3 can be solid or hollow, including a cylinder, a cone, a tube and the like.

The olive-like 93 shaped asymmetric bidirectional truncated cone body 71 is characterized by being formed by oppositely jointing two symmetrical lower bottom surfaces of two truncated cone bodies, wherein the two truncated cone bodies have identical lower bottom surfaces and upper top surfaces, but different taper heights; wherein the upper top surfaces of the two truncated cone bodies are located at two ends of the bidirectional truncated cone body 71, and are respectively jointed with the upper top surfaces of the adjacent bidirectional truncated cone bodies 71, and the outer surface of the truncated cone body 7 is provided with the asymmetric bidirectional truncated cone body conical surface 72. The external thread 9 includes the truncated cone body first helical conical surface 721 and the truncated cone body second helical conical surface 722 as well as an outer helical line 8. In the cross section through which the thread axis 02 passes, the complete single asymmetric bidirectional tapered external thread 9 is an olive-like 93 shaped special bidirectional conical geometry which is large in the middle and small in two ends and has the taper of the left truncated cone body being larger than that of the right truncated cone body. The included angle formed by two tessellation limes of the left conical surface namely truncated cone body first helical conical surface 721 of the asymmetric bidirectional truncated cone body 71 is the first taper angle α1. The truncated cone body first helical conical surface 721 forms the left taper 95 corresponding to the first taper angle α1 and is in left-direction distribution 97, and the included angle between the two tessellation lines of the right conical surface namely truncated cone body second helical conical surface 722 of the asymmetric bidirectional truncated cone body 71 is the second taper angle α2. The truncated cone body second helical conical surface 722 forms the right taper 96 corresponding to the second taper angle α2 and is in right-direction distribution 98. The tapers corresponding to the first taper angle α1 and the second taper angle α2 are opposite in direction. The tessellation line refers to an intersecting line of the conical surface and the plane through which the cone axis 01 passes. A shape formed by the truncated cone body first helical conical surface 721 and the truncated cone body second helical conical surface 722 of the bidirectional truncated cone body 71 is the same as a shape of a helical outer flank of the rotating body, wherein the rotating body is formed by the right-angled trapezoid union being rotated around the right-angled side of the right-angled trapezoid union, and, at the same time, the right-angled trapezoid union axially moves at a constant speed along the central axis of the columnar body 3; wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the columnar body 3. The right-angled trapezoid union refers to a special geometry in which the lower bottom sides are the same and upper bottom sides are the same but right-angled sides are different, and the lower bottom sides of two right-angled trapezoids are symmetric and oppositely jointed, and the upper bottom sides are respectively at the two ends of the right-angled trapezoid union.

The internal thread 6 is arranged on the inner surface of the cylindrical body 2, the cylindrical body 2 includes a nut body 21, the inner surface of the nut body 21 is provided with helically distributed tapered holes 4, the tapered hole 4 includes the asymmetric bidirectional tapered hole 41, the asymmetric bidirectional tapered hole 41 is an olive-like 93 shaped special bidirectional tapered geometry, and the cylindrical body 2 includes workpieces and objects that need to be machined with external threads on their inner surfaces.

The olive-like 93 shaped asymmetric bidirectional tapered hole 41 is formed by oppositely jointing two symmetrical lower bottom surfaces of two tapered holes, wherein the two tapered holes have identical lower bottom surfaces and upper top surfaces, but different taper heights; wherein the upper top surfaces of the two tapered holes are located at two ends of the bidirectional tapered holes 41, and are respectively jointed with the upper top surface of the adjacent bidirectional tapered holes 41. The tapered hole 4 includes an asymmetric bidirectional tapered conical surface 42. The internal thread 6 includes the tapered hole first helical conical surface 421 and the tapered hole second helical conical surface 422 as well as an inner helical line 5. In the cross section through which the thread axis 02 passes, the complete single-pitch asymmetric bidirectional tapered internal thread 6 is an olive-like 93 shaped special bidirectional conical geometry which is large in the middle and small in two ends and has the taper of the left tapered hole being larger than that of the right tapered hole. The included angle formed by two tessellation limes of the left conical surface namely tapered hole first helical conical surface 421 of the bidirectional tapered hole 41 is the first taper angle α1. The tapered hole first helical conical surface 421 forms the left taper 95 corresponding to the first taper angle α1 and is in left-direction distribution 97, and the included angle between the two tessellation lines of the right conical surface namely tapered hole second helical conical surface 422 of the bidirectional tapered hole 41 is the second taper angle α2. The tapered hole second helical conical surface 422 forms the right taper 96 corresponding to the second taper angle α2 and is in right-direction distribution 98. The tapers corresponding to the first taper angle α1 and the second taper angle α2 are opposite in direction. The tessellation line refers to an intersecting line of the conical surface and the plane through which the cone axis 01 passes. A shape formed by the tapered hole first helical conical surface 421 and the tapered hole second helical conical surface 422 is the same as a shape of a helical outer flank of a rotating body, wherein the rotating body is formed by two bevels of a right-angled trapezoid union being rotated around a right-angled side of the right-angled trapezoid union, and, at the same time, the right-angled trapezoid union axially moves at a constant speed along a central axis of the cylindrical body 2; wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the cylindrical body 2. The right-angled trapezoid union refers to a special geometry in which the bottom sides are the same and upper bottom sides are the same but the right-angled sides are different, and the lower bottom sides of two right-angled trapezoids are symmetric and oppositely jointed, and the upper bottom sides are respectively at the two ends of the right-angled trapezoid union.

In the olive-like shaped asymmetric bidirectional thread connection pair in this embodiment, an junction between adjacent helical conical surfaces of the external thread 9 and an junction between adjacent helical conical surfaces of the internal thread 6 adopt sharp angle connection forms, and the sharp angle, relative to the non-sharp angle, refers to a structure form processed by the non-sharp angle.

The olive-like 93 shaped bidirectional truncated cone body 71 and bidirectional tapered hole 41 are characterized in that at the junction between the truncated cone body first helical conical surface 721 and the truncated cone body second helical conical surface 722 of the same helical bidirectional truncated cone body 71, the large diameter of the external thread 9 is connected by the outer sharp angle structure, and a helically distributed outer helical line 8 is formed; at the junction between the truncated cone body first helical circular conical surface 721 of the same helical bidirectional truncated cone body 71 and the truncated cone body second helical conical surface 722 of the adjacent bidirectional truncated cone body 71 and/or at the junction between the truncated cone body second helical conical surface 722 of the same helical bidirectional truncated cone body 71 and the truncated cone body first helical conical surface 721 of the adjacent bidirectional truncated cone body 71, the small diameter of the external thread 9 is connected by using the inner sharp angle structure and a helically distributed outer helical line 8 is formed; at the junction between the tapered hole first helical conical surface 421 of the same helical bidirectional tapered hole 41 and the tapered hole second helical conical surface 422, the large diameter of the internal thread 6 is connected by using the inner sharp angle shape and a helically distributed inner helical line 5 is formed; at the junction between the tapered hole first helical conical surface 421 of the same helical bidirectional tapered hole 41 and the tapered hole second helical conical surface 422 of the adjacent bidirectional tapered hole 41 and/or at the junction between the tapered hole second helical conical surface 422 of the same helical bidirectional tapered hole 41 and the tapered hole first helical conical surface 421 of the adjacent bidirectional tapered hole 41, the small diameter of the internal thread 6 is connected by using the outer sharp angle structure and a helically distributed inner helical line 5 is formed. The thread structure 1 is more compact, higher in strength, large in bearing force, has good mechanical connection, locking property, sealing property and spacious tapered thread processing physical space.

When being in transmission connection, the olive-like shaped asymmetric bidirectional tapered thread connection pair is in bidirectional bearing through screw connection of the bidirectional tapered hole 41 and the bidirectional truncated cone body 71. When the external thread 9 and the internal thread 6 constitute the thread pair 10, there must be a clearance 101 between the internal thread 6 and the external thread 9, that is, there must be a clearance 101 between the bidirectional truncated cone body 71 and the bidirectional tapered hole 41. If there is an oily medium between the internal thread 6 and the external thread 9 for lubrication, a bearing oily film will be easily formed, and the clearance 101 is beneficial to formation of the bearing oily film. The asymmetric bidirectional thread connection pair 10 is equivalent to a group of sliding bearing pairs composed of one pair and/or several pairs of sliding bearings, that is, each bidirectional tapered internal thread 6 bi-directionally receives a corresponding bidirectional external thread 9 so as to form a pair of sliding bearings. The number of the formed sliding bearings is adjusted according to application working conditions, that is, the bidirectional tapered internal thread 6 and the bidirectional tapered external thread 9 are effectively and directionally jointed, that is, the number of containing-contained threads that are effectively and directionally in contact cohesion is designed according to application working conditions, the bidirectional outer cone 9 is received through the bidirectional inner cone 6 and is positioned in multiple directions such as radial, axial, angular and circumferential directions, so as to form a special cone pair and thread pair synthesis technology to ensure the tapered thread technology, especially the accuracy, efficiency and reliability of the transmission connection of the olive-like shaped asymmetric bidirectional tapered thread connection pair 10.

When the olive-like shaped asymmetric bidirectional tapered connection pair in this embodiment is in fastening connection and in seal connection, its technical performances such as connection, locking, anti-loosening, bearing, fatigue and sealing are realized by screw connection of the bidirectional tapered hole 41 and the bidirectional truncated cone body 71, that is, are realized by fixed-diameter interference between the truncated cone body first helical conical surface 721 and the tapered hole first helical conical surface 421 and/or fixed-diameter interference between the truncated cone body second helical conical surface 722 and the tapered hole second helical conical surface 422. According to application working conditions, bearing in one direction and/or simultaneous and respective bearing in two directions are achieved, that is, the bidirectional truncated cone body 71 and the bidirectional tapered hole 41 are subjected to centring of the inner and outer diameters of the inner cone and the outer cone under the guidance of the helical line till the tapered hole first helical conical surface 421 and the truncated cone body first helical conical surface 721 are cohered till interference contact and/or the tapered hole second helical conical surface 422 and the truncated cone body second helical conical surface 722 are cohered till interference contact, thereby realizing technical performances of mechanical mechanisms, such as connection, locking, loosening prevention, bearing, fatigue and sealing.

Therefore, transmission accuracy, transmission effectiveness, bearing capability, self-locking force, loose prevention capability, sealing property and other technical properties of the olive-like shaped asymmetric tapered thread connection pair 10 in this embodiment are related to the truncated cone body first helical conical surface 721 and its formed left taper 95 namely first taper angle α1 and the truncated cone body second helical conical surface 722 and its formed right taper 96 namely second taper angle α2 as well as the tapered hole first helical conical surface 421 and its formed left taper 95 namely first taper angle α1 and the tapered hole second helical conical surface 422 and its formed right taper 96 namely second taper angle α2. The material friction coefficients, machining qualities and application workings condition of the columnar body 3 and the cylindrical body 2 can also affect cone fit to a certain extent.

In the olive-like shaped asymmetric bidirectional thread connection pair, when the right-angled trapezoid union rotates a circle at a constant speed, the axial movement distance of the right-angled trapezoid union is at least double a length of the sum of the right-angled sides of two right-angled trapezoids with the same lower bottom sides and the same upper bottom sides but different right-angled sides. This structure ensures that the truncated cone body first helical conical surface 721 and the truncated cone body second helical conical surface 722 as well as the tapered hole first helical conical surface 421 and the tapered hole second helical conical surface 422 have enough lengths, thus ensuring that the bidirectional truncated cone body conical surface 72 and the bidirectional tapered hole conical surface 42 have sufficiently effective contact areas and strengths and efficiency required by helical movement when being fit.

In the olive-like shaped asymmetric bidirectional thread connection pair, the movement distance of the right-angled trapezoid union in the axial direction when rotating one revolution at a constant speed is equal to the total length of right-angled sides of two right-angled trapezoids with the same lower bottom sides and the same upper bottom sides but different right-angled sides. This structure ensures that the truncated cone body first helical conical surface 721 and the truncated cone body second helical conical surface 722 as well as the tapered hole first helical conical surface 421 and the tapered hole second helical conical surface 422 have enough lengths, thus ensuring that the bidirectional truncated cone body conical surface 72 and the bidirectional tapered hole conical surface 42 have sufficiently effective contact areas and strengths and efficiency required by helical movement when being fit.

In the above olive-like shaped asymmetric bidirectional tapered thread connection pair, both of the truncated cone body first helical conical surface 721 and the truncated cone body second helical conical surface 722 are continuous helical surfaces or non-continuous helical surfaces; both of the tapered hole first helical conical surface 421 and the tapered hole second helical conical surface 422 are continuous helical surfaces or non-continuous helical surfaces. Preferably, here, the truncated cone body first helical conical surface 721 and the truncated cone body second helical conical surface 722 as well as the tapered hole first helical conical surface 421 and the tapered hole second helical conical surface 422 are continuous helical surfaces.

In the above olive-like shaped asymmetric bidirectional tapered thread connection pair, the connection hole of the cylindrical body 2 is screwed into the screw-in end of the columnar body 3, the screw-in direction is required, that is, the connection hole of the cylindrical body 2 cannot be screwed in along the opposition direction.

In the above olive-like shaped asymmetric bidirectional tapered thread connection pair, one end of the columnar body 3 is provided with a head having a size larger than the outer diameter of the columnar body 3 and/or the one end or two ends of the columnar body 3 are provided with a head having a size smaller than the small diameter of the tapered thread external thread 9 of the screw body 31 of the columnar body 3, the connection hole is the thread hole formed on the nut body 21. That is, the columnar body 3 herein and the head are connected to form the bolt, and the bolt which has no head and/or heads at the two ends being smaller than the small diameter of the bidirectional tapered external thread 9 and/or has no thread in the middle and bidirectional tapered external threads 9 respectively at two ends is a double-screw bolt, and the connection hole is formed in the nut body 21.

Compared with the prior art, the olive-like shaped asymmetric bidirectional tapered thread connection pair has the advantages of reasonable design, simple structure, convenient operation, large locking force, large bearing force, good anti-loosing property, high transmission efficiency and accuracy, good mechanical seal effect and good stability, is capable of preventing release when connection and has self-locking and self-positioning functions, and fastening and connection functions are achieved through sizing of the conical pair formed by inner and outer cones till interference fit.

### Embodiment 2

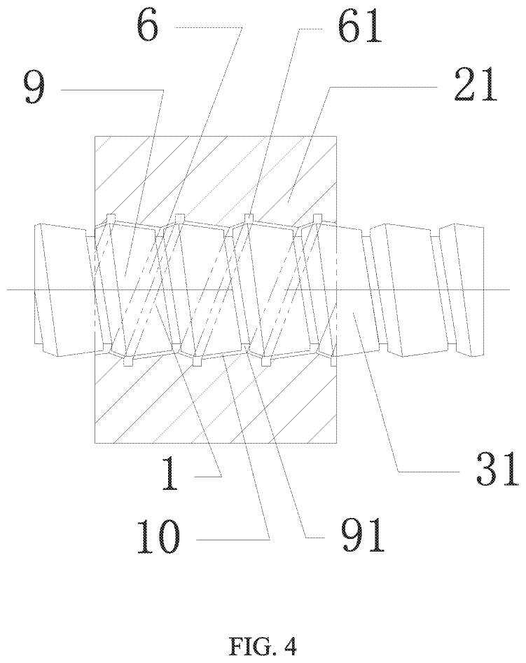

As shown in FIG. 4, the structure, principle and implementation steps of this embodiment are the same as those in embodiment 1. The difference is that the small diameter of the external thread 9 namely the junction of adjacent helical conical surfaces is processed by using the outer helical structure connected with the groove 91, the outer helical structure is a special helical line 8, the large small of the internal thread 6 is processed by using the inner helical structure connected with the groove 61, the inner helical structure is a special helical line 5, interference is avoided to be generated when the internal thread 6 and the external thread 9 are screwed, and oil and dirt can also be stored.

### Embodiment 3

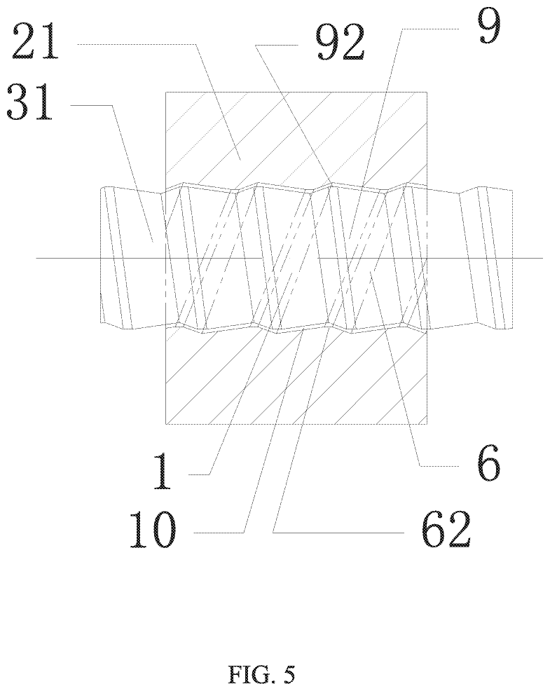

As shown in FIG. 5, the structure, principle and implementation steps of this embodiment are the same as those in embodiment 1. The difference is that the large diameter of the external thread 9 is processed by using the outer helical line structure connected with the plane or arc 92, the outer helical structure is a special helical line 8, the small diameter of the internal thread 6 namely the junction of adjacent helical conical surfaces is processed by using the inner helical structure connected with the plane or arc 62, the inner helical structure is a special helical line 5, interference is avoided to be generated when the internal thread 6 and the external thread 9 are screwed, and oil and dirt can also be stored.

### Embodiment 4

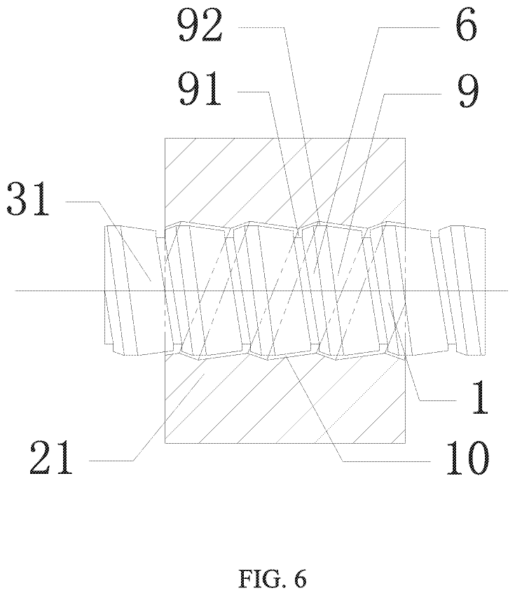

As shown in FIG. 6, the structure, principle and implementation steps of this embodiment are the same as those in embodiment 1. The difference is that the small diameter of the external thread 9 namely the junction of the adjacent helical conical surfaces is processed by using the outer helical line structure connected with the groove 91, the large diameter of the external thread 9 is processed by using the outer helical structure connected with the plane or arc 92, the outer helical structure is a special helical line 8, the large diameter and small diameter of the internal thread 6 constituting the thread pair 10 together with the external thread are connected by using sharp angles, R angle possibly existing when the thread pair 10 is formed can be avoided, interference is avoided when the internal thread 6 and the external thread 9 are screwed, and oil and dirt can also be stored.

### Embodiment 5

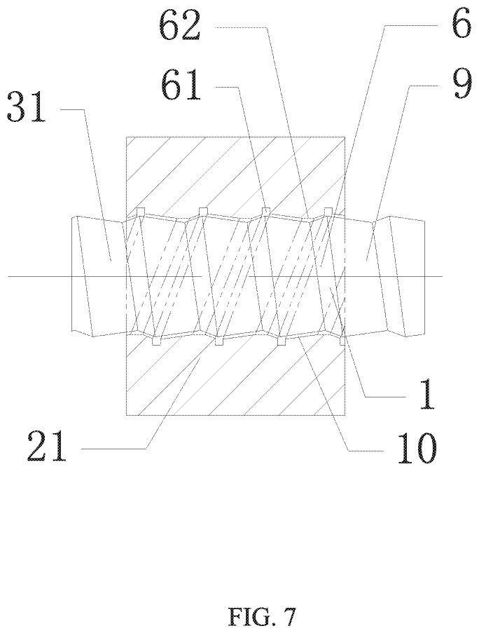

As shown in FIG. 7, the structure, principle and implementation steps of this embodiment are the same as those in embodiment 1. The difference is that the large diameter of the internal thread 6 is processed by using the inner helical line structure connected with the groove 61, the small diameter of the internal thread 6 namely the junction of adjacent helical conical surfaces is processed by using the inner helical structure connected with the plane or arc 62, the inner helical structure is a special helical line 5, the large diameter and small diameter of the external thread 9 constituting the thread pair 10 together with the external thread are connected by using sharp angles, R angle possibly existing when the thread pair 10 is formed can be avoided, interference is avoided when the internal thread 6 and the external thread 9 are screwed, and oil and dirt can also be stored.

Embodiments of the disclosure are only exemplified for the spirit of the disclosure. Those skilled in the art can make various modifications or supplementations to the described embodiments or use similar manners for replacement, which are not depart from the spirit of the disclosure or go beyond scope defined by the claims.

Although the present application uses terms such as tapered thread 1, cylindrical patent body 2, nut body 21, columnar patent body 3, screw body 31, tapered hole 4, bidirectional tapered hole 41, bidirectional tapered hole conical surface 42, tapered hole first helical conical surface 421, first taper angle α1, tapered hole second helical conical surface 422, second taper angle α2, inner helical line 5, internal thread 6, bidirectional tapered internal thread groove 61, bidirectional tapered internal thread plane or arc 62, truncated cone body 7, bidirectional truncated cone body 71, bidirectional truncated cone body conical surface 72, truncated cone body first helical conical surface 721, first taper angle α1, truncated cone body second helical conical surface 722, first taper angle α2, outer helical line 8, external thread 9, bidirectional tapered external thread groove 91, bidirectional tapered external thread plane or arc 92, olive-like 93, left taper 95, right taper 96, left distribution 97, right distribution 98, thread connection pair and/or thread pair 10, clearance 101, self-locking force, self locking, self positioning, pressure, cone axis 01, thread axis 02, mirror image, axle sleeve, shaft, non-entity space, material entity, single tapered body, dual tapered body, cone, inner cone, tapered hole, outer cone, tapered body, cone pair, helical structure, helical motion, thread body, complete unit thread, axial force, axial force angle, counter-axial force, counter-axial force angle, centripetal force, counter centripetal force, counter collineation, internal stress, bidirectional force, unidirectional force, sliding bearing, sliding bearing pair, but are not exclusive of other terms, and use of these terms are only for more conveniently describing and explaining the essence of the disclosure, and explaining them into any additional limitation is contrary to the spirit of the disclosure.

We claim:

1. An olive-shaped asymmetric bidirectional tapered thread connection pair having a large left taper and a small right taper, namely, an olive-like (left taper is larger than right taper) shaped asymmetrical bidirectional tapered thread connection pair, comprising: an external thread (9) and an internal thread (6) which are in mutual thread fit, wherein the complete unit thread of the olive-like (left taper is larger than right taper) shaped asymmetric bidirectional tapered internal thread (1) is a helical olive-like (93) shaped asymmetric bidirectional tapered thread which is large in the middle and small in two ends, has a left taper (95) being larger than a right taper (96) and comprises a bidirectional tapered hole (41) and/or bidirectional truncated cone body (71);
the thread body of the internal thread (6) is presented by a helical bidirectional tapered hole (41) on the inner surface of the cylindrical body (2) and exists in a form of “non-entity space”, the thread body of the external thread (9) is presented by a helical bidirectional truncated cone body (71) on the outer surface of the columnar body (3) and exists in a form of “material entity”;
the left conical surface of the asymmetric bidirectional tapered body forms the left taper (95) corresponding to a first taper angle (α1), the right conical surface forms the right taper (96) corresponding to a second taper angle (α2), the left taper (95) and the right taper (96) are opposite in direction and different in taper;
the internal thread (6) and the external thread (9) contain cone bodies in the tapered holes till inner and outer conical surfaces bear each other;
the technical performance mainly depends on the conical surfaces and tapers of the mutually matched threaded bodies, preferably, 0°<first taper angle (α1)<53°, 0°<second taper angle (α2)<53°; and for individual special fields, preferably, 53°≤first taper angle (α1)<180°.

2. The thread connection pair according to claim 1, wherein the olive-like (93) shaped bidirectional tapered internal thread (6) comprises a left conical surface namely a tapered hole first helical conical surface (421) and a right conical surface namely a tapered hole second helical conical surface (422) of the bidirectional tapered hole conical surface (42) and an inner helical line (5);
a shape formed by the tapered hole first helical conical surface (421) and the tapered hole second helical conical surface (422) namely a bidirectional helical conical surface is the same as a shape of a helical outer flank of a rotating body, wherein the rotating body is formed by two bevels of a right-angled trapezoid union being rotated around a right-angled side of the right-angled trapezoid union, and, at the same time, the right-angled trapezoid union axially moves at a constant speed along a central axis of the cylindrical body (2); wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the cylindrical body (2);
the above olive-like (93) shaped bidirectional tapered hole external thread (9) comprises the left conical surface namely a truncated cone body first helical conical surface (721) and a right conical surface namely a truncated cone body second helical conical surface (722) of the bidirectional truncated cone body conical surface (72) and an outer helical line (8);
a shape formed by the truncated cone body first helical conical surface (721) and the truncated cone body second helical conical surface (722) namely a bidirectional helical conical surface is the same as a shape of a helical outer flank of the rotating body, wherein the rotating body is formed by the right-angled trapezoid union being rotated around the right-angled side of the right-angled trapezoid union, and, at the same time, the right-angled trapezoid union axially moves at a constant speed along the central axis of the columnar body (3); wherein the right-angled trapezoid union is formed by oppositely jointing two symmetrical lower bottom sides of two right-angled trapezoids; wherein the two right-trapezoids have identical lower bottom sides and upper bottom sides, and different right-angled sides; wherein the two right-trapezoids are coincident with the central axis of the columnar body (3).

3. The thread connection pair according to claim 2, wherein when the right-angled trapezoid union rotates a circle at a constant speed, the axial movement distance of the right-angled trapezoid union is at least double a length of the sum of the right-angled sides of the two right-angled trapezoids of the right-angled trapezoid union.

4. The thread connection pair according to claim 2, wherein when the right-angled trapezoid union rotates a circle at the constant speed, the axial movement distance of the right-angled trapezoid union is equal to a length of the sum of the right-angled sides of the two right-angled trapezoids of the right-angled trapezoid union.

5. The thread connection pair according to claim 1, wherein the left conical surface and the right conical surface of the bidirectional tapered body namely the tapered hole first helical conical surface (421), the tapered hole second helical conical surface (422) and the inner helical line (5) are all continuous helical surfaces or non-continuous helical surfaces and/or the truncated cone body first helical conical surface (721), the truncated cone body second helical conical surface (722) and the outer helical line (8) are all continuous helical surfaces or non-continuous helical surfaces.

6. The connection pair according to claim 1, wherein the helical olive-like (93) shaped asymmetrical bidirectional tapered internal thread (6) is formed by oppositely jointing two symmetrical lower bottom surfaces of two tapered holes (4), wherein the two tapered holes have identical lower bottom surfaces and upper top surfaces but different taper heights; wherein the upper top surfaces of the two tapered holes are located at two ends of the bidirectional tapered holes (41), and are respectively jointed with the upper top surface of the adjacent bidirectional tapered holes;
the helical olive-like (93) shaped asymmetrical bidirectional tapered external thread (9) is formed by oppositely jointing two symmetrical lower bottom surfaces of two truncated cone bodies (7), wherein the two truncated cone bodies have identical lower bottom surfaces and upper top surfaces, but different taper heights; wherein the upper top surfaces of the two truncated cone bodies are located at two ends of the bidirectional truncated cone body (71), and are respectively jointed with the upper top surfaces of the adjacent bidirectional truncated cone bodies (71).

7. The thread connection pair according to claim 1, wherein the large diameter of the external thread (9) adopts an outer sharp-angle-shaped structure, the small diameter of the external thread (9) adopts an inner sharp-angle-shaped structure, the large diameter of the internal thread (6) adopts an inner sharp-angle-shaped structure, the small diameter of the internal thread (6) adopts an outer sharp-angle-shaped structure and/or the small diameter of the external thread (9) is processed by using a groove (91) structure, the large diameter of the internal thread (6) is processed by using a groove (61) structure, the large diameter of the external thread (9) and the small diameter of the internal thread (6) maintain a sharp-angle structure and/or the large diameter of the external thread (9) is processed by using a plane or arc (92) structure, the small diameter of the internal thread (6) is processed by using a plane or arc (62) structure, the small diameter of the external thread (9) and the large diameter of the internal thread (6) maintain the sharp-angle structure and/or the small diameter of the external thread (6) is processed by using a groove (91) structure, the large diameter of the internal thread (6) is processed by using a groove (61) structure, the large diameter of the external thread (9) is processed by using the plane or arc (92) structure, and the small diameter of the internal thread (6) is processed by using the plane or arc (62) structure.

8. The thread connection pair according to claim 1, wherein when the internal thread (6) and the external thread (9) constitute a thread pair (10), the thread pair (10) is formed by conical pairs constituted by mutual fixed-diameter fit between a helical bidirectional tapered hole (41) and a helical bidirectional truncated cone body (71) under the guidance of a helical line, and a clearance (101) is formed between the helical bidirectional truncated cone body (71) and the bidirectional tapered hole (41), each internal thread (6) receives a corresponding external thread (9) to constitute a pair of sliding bearings via coaxial centring and sizing, the entire thread connection pair (10) is composed by a pair or a plurality of pairs of sliding bearings, the internal thread (6) and the external thread (9) are effectively and bi-directionally jointed, namely, the number of effectively and bi-directionally cohered contained-containing threads is designed according to application work conditions, the truncated cone body (7) of the external thread (9) is bi-directionally received in the tapered hole (4) of the internal thread (6) and positioned in multiple directions such as radial, circumferential, axial and angular directions, and each internal thread (6) and each external thread (9) comprise bidirectional bearing in one side and/or bidirectional bearing at two sides.

9. The thread connection pair according to claim 1, wherein when the internal thread (6) and the external thread (9) constitute a thread pair (10), the tapered hole first helical conical surface (421) and the tapered hole second helical conical surface (422) as well as the truncated cone body first helical conical surface (721) and the truncated cone body helical conical surface (722) which are mutually fit use contact surfaces as bearing surfaces, and the internal and external diameters of the inner cone and the outer cone are centered under the guidance of the helical line till the bidirectional tapered hole conical surface (42) and the bidirectional truncated cone body conical surface (72) are cohered to reach bearing on the helical conical surface in one direction and/or simultaneous bearing on the helical conical surface in two directions and/or till fixed-diameter self-positioning contact and/or till fixed-diameter interference contact to generate self locking.

10. The thread connection pair according to claim 1, wherein the columnar body (3) is solid or hollow, comprising cylindrical and/non-cylindrical workpieces and objects which need to be machined with the bidirectional external thread (9) on the outer surfaces, the cylindrical body (2) comprises cylindrical and/or non-cylindrical workpieces and objects which need to be machined with the bidirectional internal thread (6) on the inner surfaces, and the inner surface and/or outer surface comprises surface geometrical shapes such as a cylindrical surface and/or non-cylindrical surface such as conical surface.

11. The thread connection pair according to claim 1, wherein the internal thread (6) and/or external thread (9) comprises a single-pitch thread body is an incomplete tapered geometry, namely, the single-pitch thread body is an incomplete unit thread.
